(19) United States
(12) Patent Application Publication
(10) Pub. No.: US 2018/0033024 A1
(43) Pub. Date: Feb. 1, 2018

(54) Behavioral Analytic System

(71) Applicant: Cisco Technology, Inc., San Jose, CA (US)

(72) Inventors: Hugo Mike Latapie, Long Beach, CA (US); Enzo Fenoglio, Issy-les-Moulineaux (FR); Andre Jean-Marie Surcouf, St Leu La Foret (FR); Joseph T. Friel, Ardmore, PA (US)

(21) Appl. No.: 15/221,844

(22) Filed: Jul. 28, 2016

(51) Int. Cl. G06Q 30/02; G06K 9/00; G06N 3/04

(52) U.S. Cl. CPC G06Q 30/0201; G06N 3/04; G06K 9/00335; G06K 9/00744; G06K 9/00778

(57) ABSTRACT

In one embodiment, a method includes obtaining a plurality of tracklets, each of the plurality of tracklets including tracklet data representing a position of a respective one of a plurality of people at a plurality of times. The method includes generating a behavioral analytic metric based on the plurality of tracklets. The method includes generating a notification in response to determining that the behavioral analytic metric is greater than a threshold.

### TECHNICAL FIELD

The present disclosure relates generally to behavioral analytic systems, and in particular, to systems, methods and apparatuses for generating behavioral analytic metrics of groups of people.

### BACKGROUND

The ongoing development, maintenance, and expansion of retail environments involve an increasing number of people in various spaces. Operators of such retail environments (and other environments in which groups of people gather) can employ crowd analytic technologies to optimize their end-user experience. However, it can be challenging to accurate generate crowd analytic data without special hardware (e.g., tracking devices or expensive cameras), particularly in crowded and occluded environments.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a diagram of crowd management system surveying a space in accordance with some implementations.

FIG. 2 is a diagram of a neural network system in accordance with some implementations.

FIG. 3 is a flowchart representation of a method of generating a behavioral analytic metric in accordance with some implementations.

FIG. 4 is a block diagram of a computing device in accordance with some implementations.

In accordance with common practice various features shown in the drawings may not be drawn to scale, as the dimensions of various features may be arbitrarily expanded or reduced for clarity. Moreover, the drawings may not depict all of the aspects and/or variants of a given system, method or apparatus admitted by the specification. Finally, like reference numerals are used to denote like features throughout the figures.

### DESCRIPTION OF EXAMPLE EMBODIMENTS

Numerous details are described herein in order to provide a thorough understanding of the illustrative implementations shown in the accompanying drawings. However, the accompanying drawings merely show some example aspects of the present disclosure and are therefore not to be considered limiting. Those of ordinary skill in the art will appreciate from the present disclosure that other effective aspects and/or variants do not include all of the specific details of the example implementations described herein. While pertinent features are shown and described, those of ordinary skill in the art will appreciate from the present disclosure that various other features, including well-known systems, methods, components, devices, and circuits, have not been illustrated or described in exhaustive detail for the sake of brevity and so as not to obscure more pertinent aspects of the example implementations disclosed herein.

### Overview

Various implementations disclosed herein include apparatuses, systems, and methods for generating a behavioral analytic metric. For example, in some implementations, a method includes obtaining a plurality of tracklets, each of the plurality of tracklets including tracklet data representing a position of a respective one of a plurality of people at a plurality of times, generating a behavioral analytic metric based on the plurality of tracklets, and generating a notification in response to determining that the behavioral analytic metric is greater than a threshold.

### Example Embodiments

Groups of people often gather in public spaces, such as retail environments (e.g., grocery stores, banks, and shopping malls), transportation environments (e.g., bus stops and train stations), living spaces (e.g., apartment buildings or condominium complexes), manufacturing and distribution environments (e.g., factories and warehouses), recreational environments (e.g., city parks and squares), and medical environments (e.g., hospitals, rehabilitation centers, emergency rooms, and doctors' offices). Operators of such public spaces can employ crowd analytic technologies to optimize the end-user experience. Crowd analytic technologies can provide information regarding queuing, demographics, groupings, and customer paths through the public spaces.

Counting, localizing, and tracking people in crowded and occluded environments is a topic of great interest in the research community. In various implementations, computer vision techniques and leading edge machine learning and deep learning algorithms can be employed to attempt to address the problem. Structured light, stereoscopic sensors, time of flight cameras, etc. can also be used to solve this problem. However, such systems and methods can fail to address the behavioral dimension of the problem addressed by various implementations described herein.

In particular, systems and method described herein can receive, as input, counting, localization, and tracking information (e.g., as time series data) of individuals in a group of people. The input is passed to a temporally aware recurrent deep neural network system with a custom loss function, topology, learning algorithm, and hyper-parameters. The neural network system can also receive, as input, other sensor data, such as parking lot sensor data, noise level sensor data, air pollution sensor data, and the like. As output, the neural network system can produce one or more behavioral analytic metrics, each regarding one or more of the individuals. For example, such a system can track individual queue wait times, compute average queue waiting times, or predict wait times for individuals entering a queue. As another example, such a system can detect a falling individual or predict that an individual is about to fall. Such a system may be particularly beneficial in a medial environment.

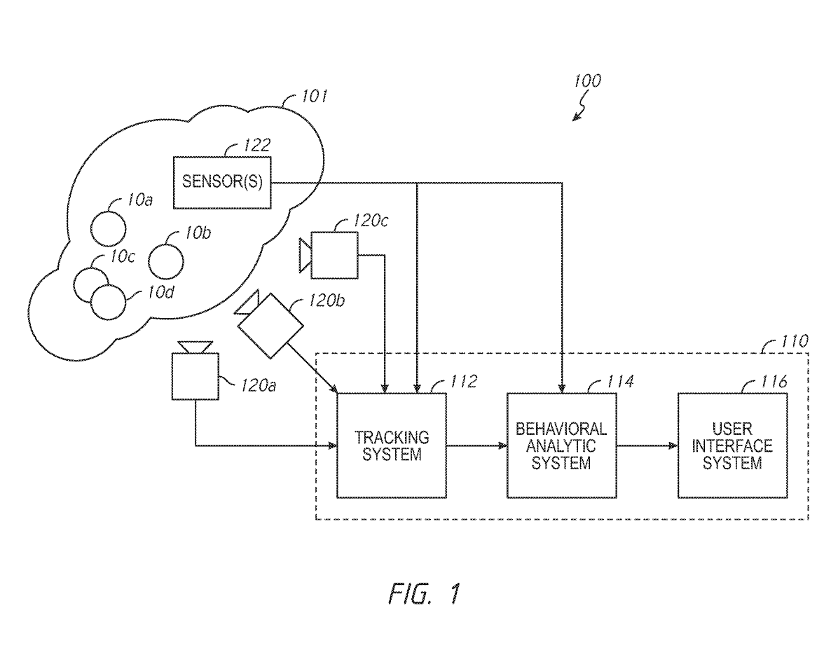

FIG. 1 is a diagram of crowd management system 100 surveying a space 101 in accordance with some implementations. The space 101 can be a public space in which a number of people 10a-10d gather. The space 101 can be, for example a retail environment, such as a grocery store, bank, or shopping mall, or a portion thereof defined by a geofence, such as a check-out area. The space 101 can be a transportation environment, such as bus stop or train station, or a portion thereof defined by a geofence, such as a ticket sales line area. The space 101 can be medical environment, such as hospital, rehabilitation center, emergency room, or doctors' office, or a portion thereof defined by a geofence, such as a check-in window area.

The crowd management system 101 includes one or more video cameras 120a-120c and one or more additional sensors 122 coupled to a backend system 110. The additional sensors 122 can include, for example, parking lot sensors, noise level sensors, CO₂ sensors, or WiFi sensors. The video cameras 120a-120c (and/or the sensors 122) can be coupled to the backend system 110 via a wired or wireless connection. In various implementations, the video cameras 120a-120c (and/or the sensors 122) are coupled to the backend system via a network (not shown). The network includes any public or private LAN (local area network) and/or WAN (wide area network), such as an intranet, an extranet, a virtual private network, a cable or satellite network, and/or portions of or the entirety of the internet. Thus, in various implementations, the backend system 110 can be implemented as a cloud-based (and scalable) system.

The backend system 110 includes a tracking system 112 that receives video of the space 101 (and the people 10a-10d therein) from the video cameras 120a-120c. In various implementations, the tracking system 112 also receives data from one or more of the sensors 122 (e.g., a WiFi sensor). The tracking system 112 processes the received data to generate spatio-temporal tracking information regarding the people 10a-10d. The tracking information can be multimodal time series data which indicates, for each of sequence of times, a count of the number of people 10a-10d in the space 101 and/or a location of each individual of the people 10a-10d in the space 101. In a particular example, the tracking information includes one or more trajectory fragments (tracklets) to provide rich spatio-temporal context for efficient tracking including tracklet data representing a position of a respective one of the plurality of people 10a-10d at a plurality of times.

In various implementations, the tracking system 112 is implemented as described in U.S. patent application Ser. No. 15/163,833, filed on May 25, 2016, entitled “METHODS AND SYSTEMS FOR COUNTING PEOPLE,” and claiming priority to U.S. Provisional Patent App. No. 62/171,700, filed on Jun. 5, 2016. Both of these applications are incorporated by reference herein in their entirety.

The backend system 110 includes a behavioral analytic system 114 that receives tracking information from the tracking system 112. In various implementations, the behavioral analytic system 114 also receives data from one or more of the sensors 122 (e.g., a parking lot sensor, a noise level sensor, or an air pollution sensor). The behavioral analytic system 114 processes the received data to generate one or more behavioral analytic metrics regarding one or more of the people 10a-10d in the space 101.

In various implementations, the behavioral analytic metric includes a wait time. For example, if the space 101 includes a check-out line in a retail environment, the wait time can be indicative of an amount of time a customer spends in the check-out line. Thus, the behavioral analytic metric can include an elapsed wait time of an individual of the group of people 10a-10d in the space 101. The behavioral analytic metric can include a predicted remaining wait time of an individual of the group of people 10a-10d in the space 101. The behavioral analytic metric can include an average total wait time of the people 10a-10d in the space 101. The behavioral analytic metric can include a predicted total wait time for a hypothetic additional individual entering the space 101.

In various implementations, the behavioral analytic metric includes a fall likelihood. For example, if the space 101 includes a medical environment, the fall likelihood can be indicative of the likelihood that an individual of the group of people 10a-10d in the space has fallen or can be indicative of the likelihood that an individual of the group of people 10a-10d is about to fall.

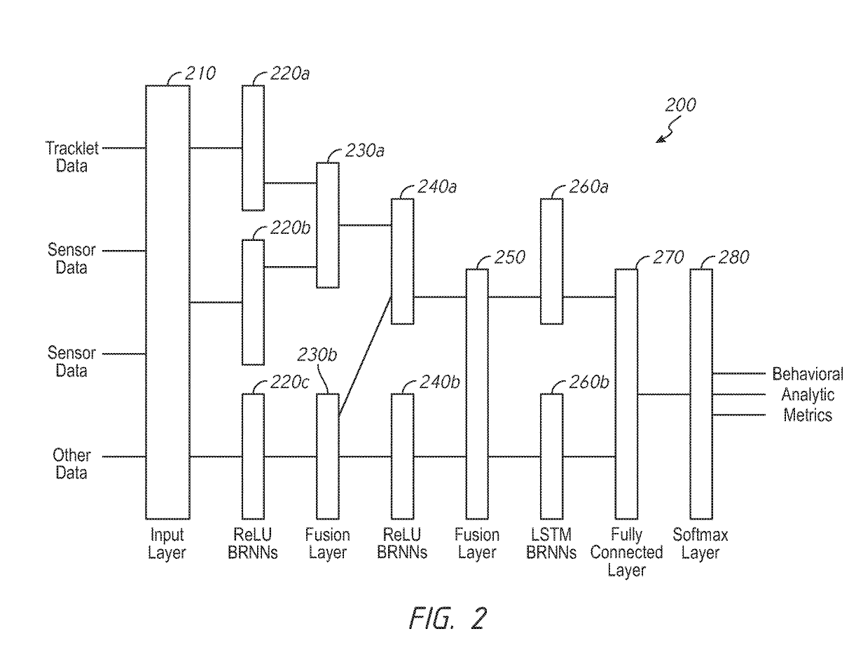

The behavioral analytic system 114 can be implemented as a neural network system as described further below with respect to FIG. 2. In particular, the behavioral analytic system 114 can be implemented as a temporally aware recurrent deep neural network system with a custom loss function, topology, learning algorithm, and hyper-parameters.

The backend system 110 includes a user interface system 116 that receives the behavioral analytic metrics from the behavioral analytic system 114. In various implementations, the user interface system 116 compares the behavioral analytic metrics to one or more thresholds and, in response to the behavioral analytic metric exceeding one or more of the thresholds, generates a notification to a user.

For example, in embodiments in which the behavioral analytic metric includes a wait time, and the wait time exceeds a threshold, the user interface system 116 can generate a notification by displaying an indication of a proposed action to increase a number of available service personnel (e.g., call more cashiers to assist in checking out customers). In various implementations, when the wait time exceeds a threshold, the user interface system 116 generates a notification by transmitting an indication of alternative service options to individuals waiting in the queue. For example, if a customer has been waiting more than a threshold amount (or is predicted to wait more than a threshold amount), a notification can be transmitted to the customer informing the customer of available self-check-out or mobile check-out options.

As another example, in embodiments in which the behavioral analytic metric includes a fall likelihood of a respective individual of the people 10a-10d in the space 101, and the fall likelihood exceeds a threshold, the user interface system 116 can generate a notification by displaying an indication of a proposed action to assist the individual. In various implementations, when the fall likelihood for an individual exceeds a threshold, the user interface system 116 generates a notification by transmitting an alert to the individual to prevent the fall.

In various implementations, the user interface system 116 can provide (e.g., display via a user interface) long-term statistics based on the behavioral analytic metrics and/or the tracking data regarding usage of the space 101. Such information can be used by operators of the space to understand the optimal layout of the space 101.

FIG. 2 is a diagram of a neural network system 200 in accordance with some implementations. In various implementations, the neural network system 200 can be used to implement the behavioral analytic system 114 of FIG. 1.

The neural network system 200 includes a number of interconnected layers. Each layer can be implemented as neural network to produce outputs based on received inputs. Each neural network includes a plurality of interconnected nodes (not shown) which instruct the learning process and produce the best output according to a suitable loss function that updates the neural network by back-propagation of the gradient of that said loss function. In various implementations, the loss functions can be any of the typical loss function (hinge loss, least square loss, cross-entropy loss, etc.) or can be a custom loss function that incorporates crowd dynamics behaviors as the negative log-likelihood of the observed tracklets data under a Fisher-VonMises distribution, or incorporates tracklets associations over probability distributions according to a linear assignment algorithm (Kuhn-Munkres, Jonker-Volgenant, etc.) among tracklet data position

The neural network system 200 includes an input layer 210 that receives tracklet data, sensor data, and, in various implementations, other data (such as a number of WiFi connections or a length of time such WiFi connections have been established). Although FIG. 2 illustrates the input layer 210 as receiving tracklet data via a single connection, it is to be appreciated that the data can include a plurality of variables and can include, for each time instance, a plurality of variables. For example, the tracklet data can include a plurality of tracklet data packets for a respective plurality of individuals. Further, each of the tracklet data packets can include a position of the individual at each of a plurality of times. Similarly, although the sensor data and other data are illustrated in FIG. 2 as being received via a single connection, it is to be appreciated that the sensor data and/or other data can include a plurality of variables.

The input layer 210 produces a number of output data streams which are each fed into a respective rectified linear unit based bidirectional recurrent neural network 220a-220c (ReLU BRNN). Although FIG. 2 illustrates three ReLU BRNNs 220a-220c, it is to be appreciated that the neural network system 200 can include any number of ReLU BRNNs coupled to the input layer 210.

Each ReLU BRNN 220a-220c produces an output data stream that is fed into one of a plurality of fusion layers 230a-230b. At least one of the fusion layers (e.g., fusion layer 230a) receives an output data stream from multiple ReLU BRNNs (e.g., ReLU BRNN 220a and ReLU BRNN 220b). Thus, in various implementations, the number of fusion layers 230a-230b is less than the number of ReLU BRNNs 220a-220c coupled to the input layer 210. Although FIG. 2 illustrates two fusion layers 230a-230b, it is to be appreciated that the neural network system 200 can include any number of fusion layers within the stage.

Each fusion layer 230a-230b produces an output data stream that is fed into at least one of a plurality of ReLU BRNNs 240a-240b. In various implementations, at least one of the ReLU BRNNs (e.g., ReLU BRNN 240a) receives an output data stream from multiple fusion layers (e.g., fusion layer 230a and fusion layer 230b). Thus, in various implementations, the number of ReLU BRNNs in the stage is equal to or greater than the number of fusion layers in the previous stage.

Each ReLU BRNN 240a-240b produces an output data stream that is fed into a fusion layer 250. The fusion layer 250 produces one or more output data streams that are respectively fed into long/short term memory bidirectional recurrent neural networks (LSTM BRNNs) 260a-260b. All of the LSTM BRNNs 260a-260b produce output data streams which are fed in a fully connected layer 270. The fully connected layer 270 produces an output data stream which is fed to a softmax (or normalized exponential) layer 280. In some implementations, the input to the softmax layer 280 produces a sparse distributed representation as a semantic fingerprint. In various implementations, the softmax layer 280 improves the accuracy and/or stability of the neural network system 200. The output of the softmax layer 280 is one or more behavioral analytic metrics.

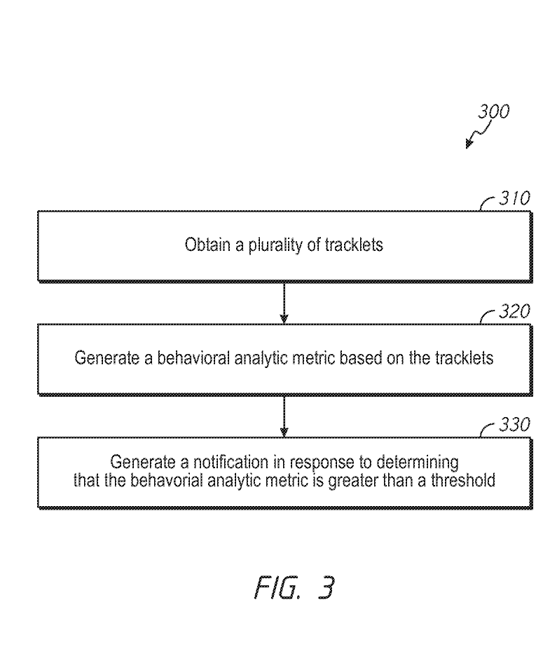

FIG. 3 is a flowchart representation of a method 300 of generating a behavioral analytic metric in accordance with some implementations. In some implementations (and as detailed below as an example), the method 300 is performed by a backend system (or a portion thereof), such as the backend system 110 of FIG. 1. In some implementations, the method 300 is performed by processing logic, including hardware, firmware, software, or a combination thereof. In some implementations, the method 300 is performed by a processor executing code stored in a non-transitory computer-readable medium (e.g., a memory). Briefly, the method 300 includes generating a behavioral analytic metric based on a plurality of tracklets.

The method 300 begins, at block 310, with the backend system obtaining a plurality of tracklets. Each of the plurality of tracklets includes tracklet data representing a position of a respective one of a plurality of people at a plurality of times. In various implementations, the backend system receives the tracklets from another source. In various implementations, the backend system generates the tracklets from received data. For example, in some embodiments, the backend system obtains, via a camera, video data representing a view of the plurality of people and generates the plurality of tracklets based on the video data. In some embodiments, the backend system defines a geofenced area and each of the plurality of tracklets includes tracklet data representing a position of a respective one of the plurality of people within the geofenced area at a plurality of times.

At block 320, the backend system generates a behavioral analytic metric based on the plurality of tracklets. In various implementations, generating the behavioral analytic metric includes generating a wait time. For example, generating the wait time can include generating at least one of an elapsed wait time of a respective one of the plurality of people, a predicted remaining wait time for a respective one of the plurality of people, an average total wait time for the plurality of people, or a predicted total wait time for an additional person.

In various implementations, generating the behavioral analytic metric includes generating a fall likelihood. For example, generating the fall likelihood can include generating a metric indicative of the likelihood that a respective one of the plurality of people has fallen or a metric indicative of the likelihood that a respective one of the plurality of people is about to fall.

In various implementations, the backend system includes a neural network system and, thus, generating the behavioral analytic metric includes providing the tracklet data to a neural network system. In various implementations, the neural network system includes one or more bidirectional recurrent neural networks. In various implementations, the neural network system includes an input layer, one or more fusion layers, and a softmax layer. In various implementations, generating the behavioral analytic metric further includes providing sensor data to the neural network system. Thus, in some embodiments, the behavioral analytic metric is based on the tracklet data and is further based on sensor data.

At block 330, the backend system generates a notification in response to determining that the behavioral analytic metric is greater than a threshold. For example, when the behavioral analytic metric is indicative of a wait time of a respective one of the plurality of people, generating the notification can include displaying an indication of a proposed action to increase a number of available service personnel or transmitting an indication of alternative service options to the respective one of the plurality of people. As another example, when the behavioral analytic metric is indicative of a fall likelihood of a respective one of the plurality of people, generating the notification can include displaying an indication of a proposed action to assist the respective one of the plurality of people or transmitting an alert to the respective one of the plurality of people. In various implementations, the method 300 can further include taking the proposed action, e.g., increasing the number of available service personnel or assisting an individual who has fallen or is about to fall.

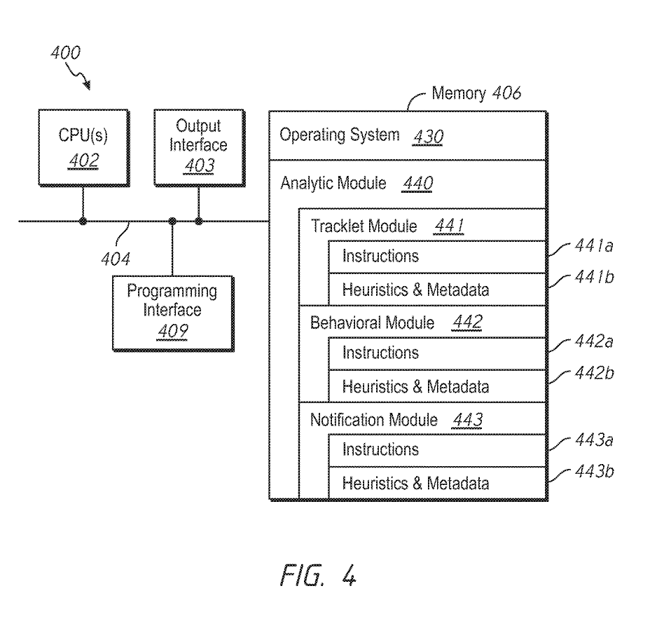

FIG. 4 is a block diagram of a computing device 400 in accordance with some implementations. In some implementations, the computing device 400 corresponds to the backend system 110 of FIG. 1 and performs one or more of the functionalities described above with respect to the backend system 110. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the computing device 400 includes one or more processing units (CPU's) 402 (e.g., processors), one or more input/output interfaces 403 (e.g., a network interface and/or a sensor interface), a memory 406, a programming interface 409, and one or more communication buses 404 for interconnecting these and various other components.

In some implementations, the communication buses 404 include circuitry that interconnects and controls communications between system components. The memory 406 includes high-speed random access memory, such as DRAM, SRAM, DDR RAM or other random access solid state memory devices; and, in some implementations, include non-volatile memory, such as one or more magnetic disk storage devices, optical disk storage devices, flash memory devices, or other non-volatile solid state storage devices. The memory 406 optionally includes one or more storage devices remotely located from the CPU(s) 402. The memory 406 comprises a non-transitory computer readable storage medium. Moreover, in some implementations, the memory 406 or the non-transitory computer readable storage medium of the memory 406 stores the following programs, modules and data structures, or a subset thereof including an optional operating system 430 and analytic module 440. In some implementations, one or more instructions are included in a combination of logic and non-transitory memory. The operating system 430 includes procedures for handling various basic system services and for performing hardware dependent tasks. In some implementations, the analytic module 440 is configured to generate one or more behavioral analytic metrics and provide notifications based on the metrics. To that end, the analytic module 440 includes a tracklet module 441, a behavioral module 442, and a notification module 443.

In some implementations, the tracklet module 441 is configured to obtain a plurality of tracklets, each of the plurality of tracklets including tracklet data representing a position of a respective one of a plurality of people at a plurality of times. To that end, the tracklet module 441 includes a set of instructions 441a and heuristics and metadata 441b. In some implementations, the behavioral module 442 is configured to generate a behavioral analytic metric based on the plurality of tracklets. To that end, the behavioral module 442 includes a set of instructions 442a and heuristics and metadata 442b. In some implementations, the notification module 443 is configured to generate a notification in response to determining that the behavioral analytic metric is greater than a threshold. To that end, the notification module 443 includes a set of instructions 443a and heuristics and metadata 443b.

Although the analytic module 440, the tracklet module 441, the behavioral module 442, and the notification module 443 are illustrated as residing on a single computing device 400, it should be understood that in other embodiments, any combination of the analytic module 440, the tracklet module 441, the behavioral module 442, and the notification module 443 can reside in separate computing devices in various implementations. For example, in some implementations each of the analytic module 440, the tracklet module 441, the behavioral module 442, and the notification module 443 reside on a separate computing device or in the cloud.

Moreover, FIG. 4 is intended more as functional description of the various features which are present in a particular implementation as opposed to a structural schematic of the embodiments described herein. As recognized by those of ordinary skill in the art, items shown separately could be combined and some items could be separated. For example, some functional modules shown separately in FIG. 4 could be implemented in a single module and the various functions of single functional blocks could be implemented by one or more functional blocks in various embodiments. The actual number of modules and the division of particular functions and how features are allocated among them will vary from one embodiment to another, and may depend in part on the particular combination of hardware, software and/or firmware chosen for a particular embodiment.

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill, and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged and certain steps and/or phases may be omitted entirely. Also, the methods described herein are to be understood to be open-ended, such that additional steps and/or phases to those shown and described herein can also be performed.

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs or GPGPUs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

The disclosure is not intended to be limited to the implementations shown herein. Various modifications to the implementations described in this disclosure may be readily apparent to those skilled in the art, and the generic principles defined herein may be applied to other implementations without departing from the spirit or scope of this disclosure. The teachings of the invention provided herein can be applied to other methods and systems, and are not limited to the methods and systems described above, and elements and acts of the various embodiments described above can be combined to provide further embodiments. Accordingly, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A method comprising:
obtaining a plurality of tracklets, each of the plurality of tracklets including tracklet data representing a position of a respective one of a plurality of people at a plurality of times;
generating a behavioral analytic metric based on the plurality of tracklets; and
generating a notification in response to determining that the behavioral analytic metric is greater than a threshold.

2. The method of claim 1, wherein obtaining the plurality of tracklets includes:
obtaining, via a camera, video data representing a view of the plurality of people; and
generating the plurality of tracklets based on the video data.

3. The method of claim 1, wherein obtaining the plurality of tracklets includes defining a geofenced area and wherein each of the plurality of tracklets includes tracklet data representing a position of a respective one of a plurality of people within the geofenced area at a plurality of times.

4. The method of claim 1, wherein generating the behavioral analytic metric includes generating a wait time.

5. The method of claim 4, wherein generating the wait time includes generating at least one of an elapsed wait time of a respective one of the plurality of people, a predicted remaining wait time for a respective one of the plurality of people, an average total wait time for the plurality of people, or a predicted total wait time for an additional person.

6. The method of claim 4, wherein generating the notification includes displaying an indication of a proposed action to increase a number of available service personnel.

7. The method of claim 4, wherein generating the notification includes transmitting an indication of alternative service options.

8. The method of claim 1, wherein generating the behavioral analytic metric includes generating a fall likelihood.

9. The method of claim 8, wherein generating the notification includes displaying an indication of a proposed action to assist a respective one of the plurality of people.

10. The method of claim 1, wherein generating the behavioral analytic metric includes providing the tracklet data to a neural network system.

11. The method of claim 10, wherein the neural network system includes one or more bidirectional recurrent neural networks.

12. The method of claim 10, wherein the neural network system includes an input layer, one or more fusion layers, a softmax layer, and a custom loss function.

13. The method of claim 10, wherein generating the behavioral analytic metric further includes providing sensor data to the neural network system.

14. A system comprising:
one or more processors; and
a non-transitory memory comprising instructions that when executed cause the one or more processors to perform operations comprising:
obtaining a plurality of tracklets, each of the plurality of tracklets including tracklet data representing a position of a respective one of a plurality of people at a plurality of times;
generating a behavioral analytic metric based on the plurality of tracklets; and
generating a notification in response to determining that the behavioral analytic metric is greater than a threshold.

15. The system of claim 14, wherein generating the behavioral analytic metric includes generating a wait time.

16. The system of claim 14, wherein generating the behavioral analytic metric includes generating a fall likelihood.

17. The system of claim 14, wherein generating the behavioral analytic metric includes providing the tracklet data to a neural network system.

18. The system of claim 17, wherein the neural network system includes one or more bidirectional recurrent neural networks.

19. The system of claim 17, wherein generating the behavioral analytic metric further includes providing sensor data to the neural network system.

20. A system comprising:
means for obtaining a plurality of tracklets, each of the plurality of tracklets including tracklet data representing a position of a respective one of a plurality of people at a plurality of times;
means for generating a behavioral analytic metric based on the plurality of tracklets; and
means for generating a notification in response to determining that the behavioral analytic metric is greater than a threshold.
